(19) United States
(12) Patent Application Publication
(10) Pub. No.: US 2026/0212006 A1
(43) Pub. Date: Jul. 23, 2026

(54) THREAT ACTOR DETECTION USING FINGERPRINTING

(71) Applicant: Oasis Security Ltd., Tel Aviv (IL)

(72) Inventor: Elad Elhanan LUZ, Tel Aviv (IL)

(73) Assignee: Oasis Security Ltd., Tel Aviv (IL)

(21) Appl. No.: 19/032,605

(22) Filed: Jan. 21, 2025

(51) Int. Cl. G06F 21/55

(52) U.S. Cl. CPC G06F 21/554; G06F 2221/034

(57) ABSTRACT

A system and method for threat actor detection. A method includes generating a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt; identifying a plurality of second access attempts involving the fingerprint; determining a success rate for the plurality of second access attempts involving the fingerprint; classifying the fingerprint as malicious based on the success rate, wherein the fingerprint is classified as malicious when the success rate is below a threshold; and performing at least one remediation action based on the classification of the fingerprint as malicious.

### TECHNICAL FIELD

The present disclosure relates generally to cybersecurity, and more specifically to detecting potential threat actors using fingerprinting with respect to access attempts.

### BACKGROUND

As modern life continues to become increasingly computerized, hackers and other malicious actors are continuing to leverage different kinds of cyberattacks in order to infiltrate systems. One such cyberattack is credential stuffing.

Credential stuffing typically involves an attacker stealing account credentials (e.g., combinations of usernames and passwords) and using the stolen credentials in order to attempt to gain unauthorized access to user accounts on other system. For example, a username and password stolen from an email provider's systems may be used in order to attempt to login to a bank account provider's systems. Because many users reuse credentials across different accounts, credential stuffing often yields as high as 2% login success rate, thereby allowing threat actors to improperly access many accounts, which means that credential stuffing tends to successfully infiltrate roughly 2 accounts for every 100 sets of credentials stolen.

Moreover, even failed credential stuffing attacks may prove problematic for users. That is, even when a credential stuffing attack does not infiltrate a given user account, the credential stuffing attack may cause other issues such as locking users out of accounts due to consecutive login failures. In this way, even failures to login can act to deny service to users.

It would therefore be advantageous to provide new techniques for detecting against cyberattacks such as credential stuffing.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for threat actor detection. The method comprises: generating a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt; identifying a plurality of second access attempts involving the fingerprint; determining a success rate for the plurality of second access attempts involving the fingerprint; classifying the fingerprint as malicious based on the success rate, wherein the fingerprint is classified as malicious when the success rate is below a threshold; and performing at least one remediation action based on the classification of the fingerprint as malicious.

Certain embodiments disclosed herein also include a non-transitory computer-readable medium having stored thereon causing a processing circuitry to execute a process, the process comprising: generating a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt; identifying a plurality of second access attempts involving the fingerprint; determining a success rate for the plurality of second access attempts involving the fingerprint; classifying the fingerprint as malicious based on the success rate, wherein the fingerprint is classified as malicious when the success rate is below a threshold; and performing at least one remediation action based on the classification of the fingerprint as malicious.

Certain embodiments disclosed herein also include a system for threat actor detection. The system comprises: a processing circuitry; and a memory, the memory containing instructions that, when executed by the processing circuitry, configure the system to: generate a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt; identify a plurality of second access attempts involving the fingerprint; determine a success rate for the plurality of second access attempts involving the fingerprint; classify the fingerprint as malicious based on the success rate, wherein the fingerprint is classified as malicious when the success rate is below a threshold; and perform at least one remediation action based on the classification of the fingerprint as malicious.

Certain embodiments disclosed herein include a method, non-transitory computer-readable medium, or system as noted above or below, wherein the plurality of factors further includes an identifier of a resource which is a target of the first access attempts.

Certain embodiments disclosed herein include a method, non-transitory computer-readable medium, or system as noted above or below, wherein the plurality of second access attempts is made to a plurality of services.

Certain embodiments disclosed herein include a method, non-transitory computer-readable medium, or system as noted above or below, wherein the fingerprint is classified as malicious based further on an error type for at least one second access attempt of the plurality of second access attempts.

Certain embodiments disclosed herein include a method, non-transitory computer-readable medium, or system as noted above or below, wherein the at least one remediation action includes defining a parameter blacklist based on the fingerprint, wherein the parameter blacklist includes a plurality of parameters such that access is blocked when the plurality of parameters is observed, wherein the plurality of parameters correspond to at least a portion of the plurality of factors.

Certain embodiments disclosed herein include a method, non-transitory computer-readable medium, or system as noted above or below, wherein the at least one remediation action includes triggering a secrets rotation process.

Certain embodiments disclosed herein include a method, non-transitory computer-readable medium, or system as noted above or below, wherein the at least one remediation action includes blacklisting the fingerprint.

Certain embodiments disclosed herein include a method, non-transitory computer-readable medium, or system as noted above or below, wherein at least one of the plurality of factors corresponds to at least one hard-coded parameter of an automated process.

Certain embodiments disclosed herein include a method, non-transitory computer-readable medium, or system as noted above or below, wherein the fingerprint is a persistent fingerprint, wherein the plurality of factors used to define the fingerprint repeat across access attempts made by an entity using an automated process.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for remediating cyberattacks using fingerprints according to an embodiment.

FIG. 3 is a flowchart illustrating a method for generating fingerprints according to an embodiment.

FIG. 4 is a flowchart illustrating a method for detecting malicious fingerprints according to an embodiment.

FIG. 5 is a flowchart illustrating a method for correlating between identities and resource access according to an embodiment.

FIG. 6 is a schematic diagram of a threat actor detector according to an embodiment.

### DETAILED DESCRIPTION

In light of the challenges noted above, it has been identified that existing solutions to address cyberattacks such as credential stuffing have disadvantages that may cause these solutions to be unsuitable for various use cases. In particular, some existing solutions may identify indicators which are detectable only after a compromise has happened. These solutions therefore cannot proactively prevent threat actors from infiltrating accounts. It has further been identified that solutions using reputation of systems (e.g., reputation of Internet Protocol addresses) may fail to detect threat actors. For example, a solution using Internet Protocol (IP) address reputation may fail to detect a threat actor when the threat actor switches IP addresses between access attempts.

To address these challenges and others, it has been determined that fingerprinting threat actors using a combination of factors identified among records of access attempts may allow for proactively detecting malicious access attempts while reducing susceptibility to threat actors avoiding detection by switching identifiers such as IP address. To this end, various disclosed embodiments include techniques for fingerprinting entities making access attempts and for detecting fingerprints belonging to threat actors or otherwise associated with malicious entities. Various disclosed embodiments further provide techniques which leverage detected malicious fingerprints in order to remediate potentially malicious access attempts, thereby mitigating credential theft and securing user accounts against threat actors.

In an embodiment, a combination of factors is utilized to generate a fingerprint for an entity attempting to access an account. In a further embodiment, at least some of the factors used for generating each fingerprint are factors identified in access data such as, but not limited to, access logs or other records of access attempts. In yet a further embodiment, the factors utilized to generate the fingerprint at least include software used for an access attempt (for example, as defined with respect to specific software, version, or both) and network location, network identifier, one or more other aspects of a network configuration of an endpoint participating in the access attempt (for example, an autonomous system number of a network or group of networks used to transmit data as part of the access attempt, an IP address of the accessing system, an identifier of an intermediary network or system used as an intermediary which initiates or otherwise participates in the access attempt, a type of such an intermediary network or system, a role of such an intermediary network or system, and the like).

In this regard, it has been identified that threat actors attempting to gain unauthorized access via credential stuffing typically automate at least a portion of activities related to access attempts. A given automated process used to realize automated access attempts will follow certain patterns across access attempts which can be fingerprinted as discussed herein. When fingerprints having certain combinations of factors are observed across different access attempts, this may be indicative of use of an automated agent. Detection of the same fingerprint across different access attempts, in tandem with other abnormalities related to such access attempts, may therefore allow for identifying potentially malicious activity and therefore detecting potential threat actors.

It is noted that fingerprints defined in this way may allow for defining remediation criteria which may be leveraged to block threat actors in a manner which is not tied to an identifier or other criteria which is typically changed in order to avoid detection, thereby improving remediation and mitigation activities realized using fingerprints as described herein.

In particular, in at least some embodiments, a fingerprint is defined using a combination of factors including a user agent string (for example, a string or otherwise text included in a user agent field in a header of a browser) or other data indicating certain software, versions of software, or both, used for an access attempt. Such a string or other text may indicate aspects of the user agent such as, but not limited to, a list of software components and corresponding versions of those software components utilized by the user agent. Alternatively, the fingerprint may be defined using software components and versions identified by parsing text among the access data which indicates software used for the access attempt.

In this regard, the user agent string may effectively define the user agent based on which software it uses including certain versions of that software. Hard-coded user agent strings will always utilize the same software such that the resulting fingerprinting factors observed for access attempts by processes using these hard-coded user agent strings will persist. Likewise, whenever an automated process is utilized, the software components and versions of those software components used by the automated process in order to enable automated access attempts tends to be hard-coded.

The fingerprints may therefore be utilized to identify entities performing access attempts across different accounts and systems. Fingerprints generated using combinations of factors may be classified as either malicious or non-malicious by analyzing appearances of the fingerprints across access attempts and identifying patterns of fingerprint usage across different access attempts, thereby allowing for detecting malicious fingerprints.

In an embodiment, classifying fingerprints includes analyzing a success rate of access attempts for each fingerprint, where fingerprints having success rates below a threshold (e.g., a predetermined threshold proportion of successes among a given set of access attempts) are classified as malicious. In a further embodiment, the success rate for each fingerprint is determined for a respective set of access attempts. The set of access attempts analyzed to determine success rate for each fingerprint may be further defined with respect to a certain period of time (e.g., a predetermined period of time prior to a time of analysis), systems to which the entity having the fingerprint attempts to authenticate, both, and the like. In some embodiments, only access attempts which occur across two or more systems are classified as malicious.

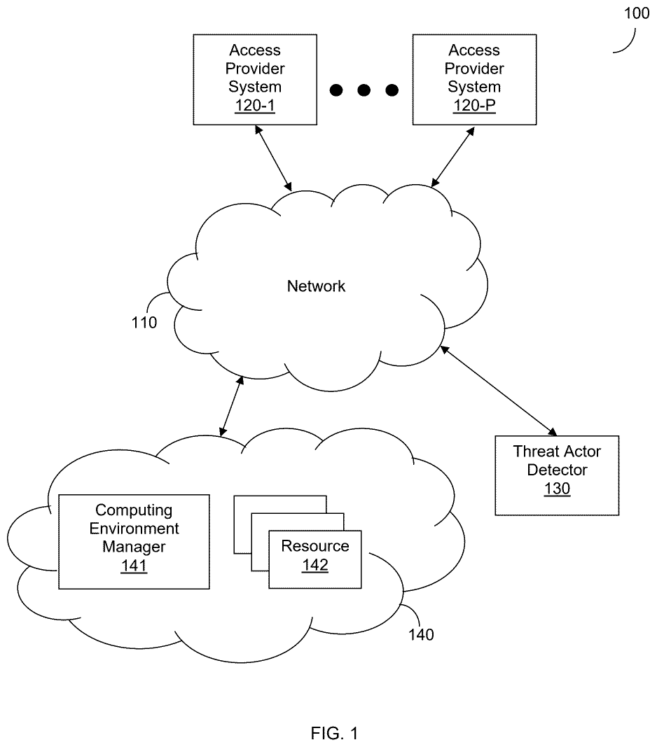

FIG. 1 shows an example network diagram 100 utilized to describe the various disclosed embodiments. In the example network diagram 100, one or more access provider systems 120-1 through 120-P (hereinafter referred to as an access provider system 120 or as access provider systems 120 for simplicity), a threat actor detector 130, and a computing environment 140 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The access provider systems 120 are configured to manage access, for example, access to resources such as the resources 142. The access provider systems 120 may be utilized to provide services such as, but not limited to, identity and access management (IAM) services. To this end, the access provider systems 120 may be configured to authenticate systems (not shown) attempting to access the resources 142 or otherwise attempting to access components of the computing environment 140.

The access provider systems 120 may store log data or other records of access attempts. Such records may indicate, for example, when access attempts were made, identifiers of accessing systems or programs (for example, an application identifier or a unique client device identifier), network configurations of accessing programs or systems (for example, network configurations defined with respect to any or all of network addresses, network identifiers, types of networks used by such accessing programs or systems, roles of networks used by such accessing programs or systems), other information related to the accessing program or system (for example, a type of client device), which resources were attempted to be accessed (for example, as indicated by resource identifiers or other recipient identifiers), from which networks or groups of networks a request for authentication is received (for example, as indicated by an autonomous system number or other identifier of a network or group of networks), whether the access attempt was successful, combinations thereof, and the like.

The threat actor detector 130 is configured to detect potential threat actors using fingerprinting based on access attempts as discussed herein. More specifically, as discussed herein, the threat actor detector 130 is configured to generate fingerprints based on data related to access attempts and to determine whether access attempts might be malicious based on the fingerprints. In an embodiment, each fingerprint is defined via a combination of factors. More specifically, the combination of factors used to define each fingerprint may be selected from among possible factors due to their tendency to be repeated in different access attempts by a given automated process. Further, the combination of factors may be defined such that the combination of factors tends to collectively repeat in access attempts in different locations, for example, in access attempts made to different access provider systems (for example, different access provider systems among the access provider systems 120).

As discussed herein, attackers attempting to gain unauthorized access to resources often utilize automated processes. These automated processes tend to leave behind traces (for example, traces represented by data in access logs or other records) which are repeatedly and consistently observed among different access attempts by the same automated process. As a result, combinations of these traces may be utilized as values for fingerprints which allow for identifying different access attempts using the same automated process. That is, rather than fingerprint the system or device performing the access attempt, the fingerprints may effectively represent the programs used by these systems or devices such that access attempts by the same threat actor may be detected by identifying instances of the same fingerprint across different access attempts. These fingerprints may be designed with combinations of factors that are resilient to identifiers or other information about the accessing systems which are frequently spoofed, modified, or otherwise changed.

As depicted in FIG. 1, the computing environment 140 includes a computing environment manager 141 and one or more resources 142. The computing environment manager 141 may be configured to control access to the resources 142 in order to secure the computing environment 140 against potential cybersecurity threats. The resources 142 may be or may include, but are not limited to, systems, applications, software containers, virtual machines, services, databases, data stores, combinations thereof, and the like. Access to the resources 142 may be controlled using the access provider systems 120, for example, by only granting such access when an accessing system is authenticated or otherwise approved by one of the access provider systems 120.

It should be noted that FIG. 1 depicts an implementation of various disclosed embodiments, but that at least some disclosed embodiments are not necessarily limited as such. Other deployments, arrangements, combinations, and the like, may be equally utilized without departing from the scope of the disclosure. In particular, multiple computing environments may be managed with respect to potential threat actors without departing from the scope of the disclosure. Additionally, in some implementations which are not shown, any or all of the access provider systems 120 may be deployed locally in the computing environment 140 and used to manage access internally within the computing environment 140.

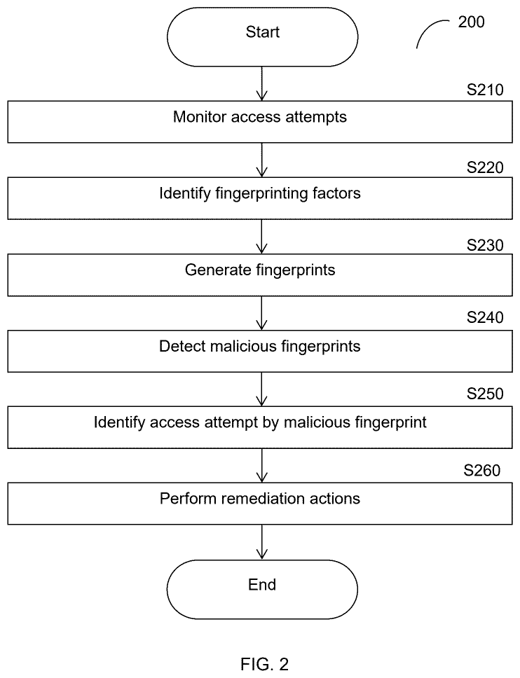

FIG. 2 is a flowchart 200 illustrating a method for remediating cyberattacks using fingerprints according to an embodiment. In an embodiment, the method is performed by a threat actor detector (for example, the threat actor detector 130, FIG. 1).

At S210, access attempts are monitored. In an embodiment, the access attempts are monitored across different times, different locations, different systems or services (for example, different access provider systems to which accessing systems authenticate), combinations thereof, and the like. More specifically, as discussed herein, access attempts may be monitored across different locations or systems in order to determine when fingerprints are repeated among those access attempts at different locations or to different systems. In a further embodiment, monitoring the access attempts includes analyzing access data such as, but not limited to, access logs or other access records, in order to identify multiple access attempts.

At S220, factors to be used for fingerprinting are identified based on the monitored access attempts. In an embodiment, identifying the fingerprinting factors includes analyzing access data for the monitored access attempts (for example, access logs or other access records) using a set of factor identification rules in order to identify the factors. The factor identification rules, in turn, may define predetermined types of factors to be used for defining fingerprints as well as how to identify values of those factors in access records. As a non-limiting example, the factor identification rules may define certain predetermined fields in which values of factors can be found for different types of records (for example, records by different sources such as, but not limited to, different access provider systems).

In some embodiments, the factors to be used for fingerprinting may include factors related to entities which made the access attempts. Such entities may not be indicated in the access data. Even when entities are indicated in the access data, the indicated entities may sometimes be intermediaries which are not the originators of the access attempts. To this end, in a further embodiment, S220 includes correlating entities to access attempts. In some embodiments, access attempts may be grouped with respect to entities, and such groupings may be used further for generating confidence scores in order to increase the confidence that a given fingerprint appearing in multiple access attempts are malicious.

At S230, fingerprints are generated using the identified fingerprinting factors. In an embodiment, each fingerprint is generated based on a combination of such factors such that, when an automated process is utilized to make multiple access attempts, fingerprints for the access attempts made by the same automated process are the same (either identical or matching within a predetermined proportion or percentage).

In a further embodiment, each fingerprint is generated using a combination of factors which are demonstrated each time an entity using a given automated process makes an access attempt using that automated process and includes one or more persistent factors which are often not changed or switched when using automated processes by a given entity.

In this regard, the fingerprints act as identifiers of a given entity that persist across access attempts. In other words, in an embodiment, each fingerprint is a persistent fingerprint defined using a combination of factors that repeat across access attempts by an entity using an automated process. To this end, in yet a further embodiment, two or more of the factors are selected based on parameters capable of being hard-coded for use by automated processes. As a non-limiting example and as discussed further below, a user agent string may be utilized as one of the factors because such user agent strings are often hard-coded such that the same user agent string appears across access attempts at different times, in different locations, or both. In other words, two or more of the factors correspond to hard-coded parameters used by processes in order to perform access attempts such that those factors are observed repeatedly when their corresponding parameters are used for automated processes across different access attempts.

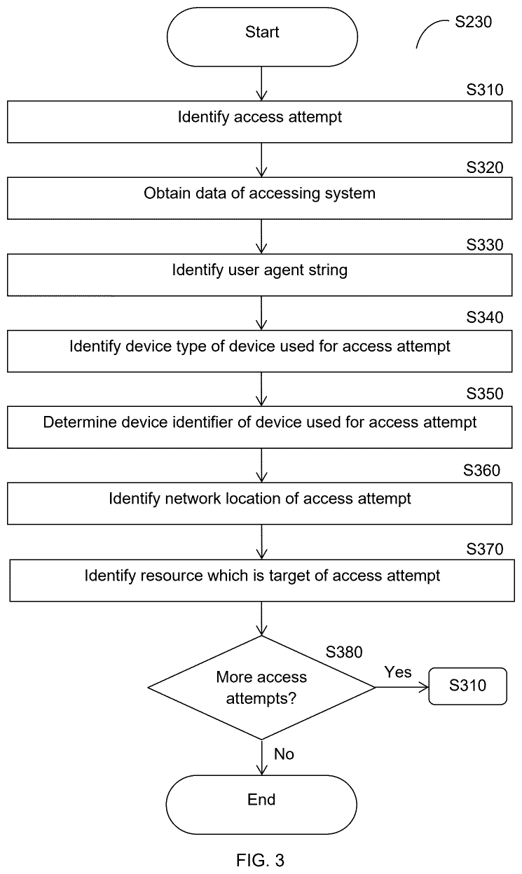

An example process for fingerprinting access attempts which may be utilized at S230 is described further below with respect to FIG. 3.

At S240, one or more malicious fingerprints are detected among the generated fingerprints. In an embodiment, detecting each malicious fingerprint includes identifying multiple access attempts involving a given fingerprint and determining whether the different access attempts are indicative of one or more malicious activities involving multiple access attempts. As a non-limiting example, such a malicious activity may be a credential stuffing attack using an automated process to attempt access using stolen credentials with a variety of access provider systems.

In some embodiments, malicious fingerprints may be recorded in a fingerprint catalog. Such a fingerprint catalog may be or may include a list of known fingerprints which were previously determined as well as results of malicious fingerprint detection. As a non-limiting example, the results of malicious fingerprint detection may indicate whether each fingerprint was detected as malicious or not such that the fingerprint catalog indicates that each fingerprint is either malicious or benign (i.e., not determined as malicious).

In a further embodiment, detecting malicious fingerprints among the generated fingerprints includes checking such a fingerprint catalog and identifying one or more of the generated fingerprints as being marked as malicious within the fingerprint catalog. The fingerprint catalog may be populated based on previous results of malicious fingerprint detection.

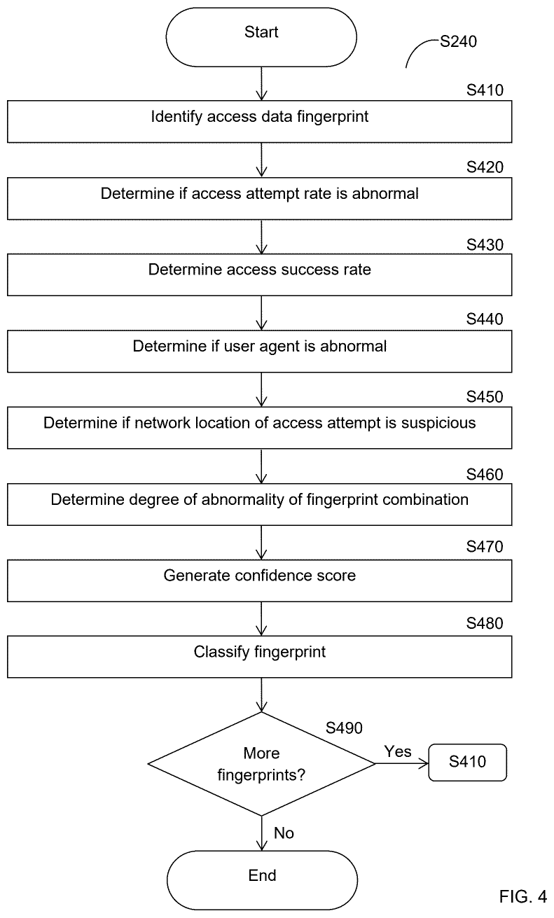

In yet a further embodiment, only fingerprints which are not already identified in the fingerprint catalog may be analyzed as discussed further below with respect to FIG. 4. Alternatively, only fingerprints which are not identified in the fingerprint catalog as being malicious may be analyzed as discussed further below with respect to FIG. 4. Analyzing any fingerprints not known to be malicious (as indicated in the fingerprint catalog) may allow for avoiding false negatives, for example, when a fingerprint has only been observed once previously and therefore has not yet been identified as malicious even though it might be.

That is, if a fingerprint is already in the fingerprint catalog when a new instance of that fingerprint is generated, the results of malicious fingerprint detection indicated in the fingerprint catalog may be used instead of reanalyzing whether the fingerprint is malicious. This may allow for conserving computing resources by avoiding performing the malicious fingerprint detection when the fingerprint has already been analyzed or when the fingerprint has already been determined to be malicious.

An example process for detecting malicious fingerprints which may be utilized at S240 is described further below with respect to FIG. 4.

At S250, access attempts by the malicious fingerprints are identified. In an embodiment, any access attempts involving a fingerprint detected as malicious at S240 are identified. These access attempts therefore represent a potential cyber threat performed by a potential threat actor such that identifying these malicious access attempts effectively allows for detecting threat actors. As noted above, because the fingerprints use a combination of factors which are not limited to identifiers which are frequently spoofed or otherwise changed, a threat actor may be detected as using the same automated process in order to perform the access attempts despite any changes to identifiers such as Internet Protocol (IP) addresses, device names, and the like.

At S260, remediation actions are performed in order to remediate the access attempts by the malicious fingerprints. In an embodiment, the remediation actions are performed in order to block access for the access attempts by the malicious fingerprints. The remediation actions may include, but are not limited to, blocking access attempts (for example, by sending notifications instructing an access provider system to block certain access attempts), blacklisting malicious fingerprints or entities whose access attempts included malicious fingerprints, triggering a secrets rotation process, sending a notification instructing users to update their secrets, defining parameter blacklists (for example, using a combination of parameters appearing in malicious fingerprints), combinations thereof, and the like.

As a non-limiting example, a catalog of fingerprints may be created or updated using results of malicious fingerprint detection, and the catalog of fingerprints may be checked against fingerprints generated for subsequent access attempts in order to identify fingerprints which were previously detected as malicious and to block access attempts which correspond to those previously detected malicious fingerprints. Conditional access rules may require that access attempts only be approved if they lack malicious fingerprints or certain combinations of parameters observed in malicious fingerprints in addition to requiring successful authentication or otherwise requiring successfully providing access credentials.

In some embodiments, performing the remediation actions includes rotating one or more secrets such as, but not limited to, secrets used for accessing certain resources or services which were among the resources and services which were attempted to be accessed. A non-limiting example process for secret rotation which may be utilized in such an embodiment is described further in U.S. patent application Ser. No. 18/412,870, assigned to the common assignee, the contents of which are hereby incorporated by reference.

FIG. 3 is a flowchart S230 illustrating a method for generating fingerprints according to an embodiment.

At S310, an access attempt is identified among a set of access data. The access attempt may be identified, for example, based on a structure of the access data. As a non-limiting example, each column or each row in a set of access data may correspond to an access attempt such that each access attempt is identified as being defined by the data in a given column or row.

At S320, data of an accessing system which made the access attempt is obtained. Such data may include, but is not limited to, device type (for example, laptop computer, personal computer, tablet computer, smartphone, etc.), device fingerprint or other unique identifier of a device, network configuration (for example, network configuration defined with respect to aspects such as, but not limited to, network location or network identifier), combinations thereof, and the like. Such data may be included in data transmitted by such a system as part of an access attempt and may be analyzed to identify potential fingerprinting factors as discussed further below.

At S330, a user agent string used by the accessing system is identified. The user agent may be, but is not limited to, a string included in a user agent field in a header of a browser. To this end, in an embodiment, S330 includes analyzing such a header in order to identify the user agent string.

In this regard, it is noted that user agents are computer programs used to represent an entity and that access attempts by non-automated users typically change frequently, for example, to reflect newer versions. Automated processes may utilize hard-coded user agents that persist across access attempts such that defining fingerprints based on user agents aids in identifying potential indicators of automated processes. Accordingly, fingerprints defined based on user agents may improve the accuracy of detecting malicious fingerprints by more accurately reflecting whether the choice of user agent reflects a likely automated process.

It is also noted that user agents may be spoofed such that identifying an instance of a user agent, by itself, is unlikely to accurately identify malicious access attempts. Various disclosed embodiments, which utilize a combination of factors including user agent strings and which involve determining whether fingerprints are observed for multiple access attempts, allows for more accurately detecting threat actors than methods which would only detect threat actors based on user agent strings (for example, by blacklisting user agents associated with certain user agent strings) or other parameters which are not hard-coded alone.

At S340, a device type of a device used for the access attempt is identified. The device type may be, for example but not limited to, a laptop computer, a personal computer, a tablet computer, a smartphone, and the like.

At S350, a device identifier of the device used for the access attempt is determined. The device identifier may be, but is not limited to, a globally unique identifier of the device, a manufacturer identifier, a device fingerprint (i.e., a fingerprint which is unique to a particular device and not a fingerprint representing a given entity generated as discussed herein), a combination thereof, and the like. Further, in some embodiments, the resource may be defined with respect to a role of the resource within a network such as, but not limited to, identifying certain network locations (for example, IP addresses) as belonging to resources such as certain equipment, companies, datacenters, servers (for example proxy servers), networks, type of networks (for example, public WiFi), combinations thereof, and the like.

At S360, a network configuration of an accessing program or system of the access attempt is identified. Such a network configuration may represent a certain network, access point, network address, type of network (for example, a virtual private network, residential network, or commercial network), network role (for example, a proxy server or TOR network), a combination thereof, and the like. In an embodiment, the accessing program or system acts as an endpoint for the access attempt. That is, the accessing program or system is an endpoint which participates in the access attempt, for example, by communicating with an access provider server or other system configured to control access using an authentication process.

The network configuration may be defined with respect to, for example but not limited to, a given network address, a network, a group of networks, a combination thereof, and the like. Such a network configuration may be defined with respect to, for example but not limited to, an Internet Protocol (IP) address, a range of IP addresses, an autonomous system number (ASN), an intermediary network or system (for example, a Tor network, a proxy server, a residential IP, a commercial IP, a virtual private network, etc.), and the like. Such an ASN is a globally unique identifier assigned to a network or group of networks, for example a network or group of networks owned or operated by a given organization.

At S370, a resource which is a target of the access attempt is identified. In an embodiment, the resource may be identified with respect to resource type, resource identifier (ID), endpoint (for example, hypertext transfer protocol [HTTP] endpoint), a combination thereof, and the like. Such a resource may be, but is not limited to, a system, service, infrastructure component, and the like.

At S380, it is checked if more access attempts have been identified and, if so, execution continues with S310; otherwise, execution terminates. As noted above, multiple access attempts involving any given fingerprint may be analyzed to detect malicious fingerprints as discussed herein (for example, with respect to FIG. 4).

FIG. 4 is a flowchart S240 illustrating a method for detecting malicious fingerprints according to an embodiment.

At S410, access data for access attempts involving a fingerprint are identified. In an embodiment, the access data includes data related to each access attempt for which the fingerprint was generated (for example, generated as discussed above with respect to S230 and FIG. 3).

At S420, it is determined whether a rate of access attempts is abnormal based on the access data for the fingerprint. The rate of access attempts may be determined as, for example, an average frequency (for example, an average number of access attempts a second for a given time window). In this regard, it is noted that threat actors frequently use automated programs which perform access attempts at a relatively consistent rate and that real users which do not use automated programs typically do not perform multiple access attempts at a consistent rate. To this end, in an embodiment, a rate of access attempts is abnormal when the rate is consistent. That is, in an embodiment, a rate of access attempts is determined to be abnormal when the times between access attempts are each within a predetermined threshold amount or proportion of time from the determined average rate of access attempts.

At S430, an access success rate is determined based on the access data for the fingerprint. The access data for each access attempt involving a given fingerprint may indicate whether the access attempt was successful. In an embodiment, the access success rate is determined for a given period of time (for example, a time window).

To this end, the access success rate may be or may be determined based on a proportion of successful access attempts involving the fingerprint and the total number of access attempts involving the fingerprint, for example, a number of successful access attempts divided by a total number of access attempts in a given time window.

In some embodiments, the access success rate is determined for a given time period such as, but not limited to, a predetermined period of time leading up to the determination, a predetermined period of time after a first observation of the fingerprint in access records (for example, within a predetermined period of time of the access attempt involving the fingerprint having the earliest timestamp), and the like. As a non-limiting example, access attempts that occurred within an hour of a periodic check for fingerprints may be analyzed to determine the access success rate.

In this regard, it is noted that credential stuffing attacks typically involve using stolen credentials in order to access a variety of services with the assumption that at least some users reuse credentials across different services (i.e., such that credentials stolen for one service may allow a threat actor to use those same credentials to access other services). As a non-limiting example, some users may use the same username and password across services such that stealing the username and password for one user's online shopping account may allow the thief to access that user's online banking account. It has been identified that, when stolen credentials are used to attempt to access different services in this way, the success rate tends to be low (for example, around 2%) since most users do not use identical sets of credentials across many services. By checking for access success rates below a predetermined threshold, confidence that the access attempt is malicious is increased, which in turn decreases the likelihood of a false negative (i.e., determining that an access attempt is not malicious when it actually is).

In some embodiments, the access success rate may be determined using only access attempts made to different services, for example but not limited to, authentication services or other services which check requirements before admitting access (for example, services realized using the access provider systems 120, FIG. 1). That is, in such embodiments, access attempts to the same service may be excluded for purposes of determining access success rate and the access success rate is determined using results of exactly one access attempt per service. In a further embodiment, when multiple access attempts are made to a given service, the most recent access attempt may be used when determining the access success rate.

In some embodiments, further details related to access failures may be utilized to improve malicious fingerprint detection. In such an embodiment, such further details include an error type or other reason behind each access failure. In a further embodiment, access attempts which yielded certain predetermined types of errors may be excluded from the success rate determination. That is, when determining the success rate, failed access attempts which yielded certain error codes or other indicators of error or failure type may be excluded when determining the total amount of access attempts such that only successful access attempts and access attempts having certain types of failures or errors are utilized to determine the total amount of access attempts and, consequently, the access success rate.

Alternatively, error types of failed access attempts may be analyzed to determine a rate of each error type or otherwise to determine for what reason the failed access attempts were not successful. As a non-limiting example, rates of errors may be determined for any or all of the following types of errors: incorrect credentials, lack of authorization to access (for example, an authentication was successful but the authenticated account is not authorized to access the target resource), invalid resource (for example, when the target resource does not exist or cannot be found), lack of capability of the access provider system, lack of capacity of the access provider system, and the like.

Certain types of errors may be predetermined as increasing confidence that a fingerprint involved in access attempts which yielded those types of errors indicates malicious behavior. To this end, in some embodiments, error rates (for example, a number of access attempts involving a fingerprint which yielded a given type of error divided by a total number of access attempts involving the fingerprint) for those types of errors which are above a predetermined threshold may be utilized to raise the confidence score. In such embodiments, the confidence score generated as described further below for a given fingerprint may be further based on such error rates for different types of errors or otherwise based on error types for access attempts involving the fingerprint.

In this regard, it is noted that certain types of errors are more commonly associated with certain types of cyberattacks perpetrated using automated processes than others. As a non-limiting example and as noted above, credential stuffing attacks are typically performed using automated processes and tend to result in failure to provide the correct credentials. That is, credential stuffing attacks tend to have a high rate of errors caused by lacking the required credentials and not, for example, errors due to invalid resource or lack of capacity to process the access attempt (each of which may be a type of error that is indicative of benign or otherwise non-malicious activity). Accordingly, excluding access attempts which yielded certain types of errors or otherwise using error types when classifying fingerprints as either malicious or non-malicious allows for improving accuracy of detecting credential stuffing attacks and other types of cyberattacks which involve automated processes that tend to yield certain types of failures.

At S440, it is determined whether a user agent represented in the access data is abnormal.

In an embodiment, a user agent of a given fingerprint is determined as abnormal when the user agent represented by the user agent string of the fingerprint appears below a predetermined threshold proportion or number of times among fingerprints. In this regard, it is noted that threat actors frequently utilize hard-coded user agents, and these user agents may be outdated or otherwise rarely used by real (non-automated) users. Accordingly, identifying such infrequently utilized user agents allows for increasing the confidence that a fingerprint including such a user agent is malicious.

Alternatively or in combination, in another embodiment, determining whether the user agent is abnormal includes checking the user agent and an application identifier against a predetermined list of known combinations of user agents and application identifiers. In this regard, it is noted that threat actors often utilize user agents which are not designed or otherwise intended to be utilized with a given application such that the user agent does not correspond to a known application identifier for that application. Such a mismatch between user agent and application identifier therefore increases confidence that a given fingerprint represents a threat actor and is a malicious fingerprint.

At S450, it is determined whether a network configuration of a source of the access attempt is suspicious. In an embodiment, a network configuration is determined as being suspicious when one or more aspects of the network configuration are among a predetermined list of known networks or network addresses (for example, Internet Protocol addresses) used for cyberattacks (for example, networks or network addresses which have been previously observed as the networks or network locations of origin for credential stuffing attacks). Such aspects of network configuration may be defined with respect to, but not limited to, an autonomous system number (ASN), a group of ASNs, an Internet Protocol (IP) address, a range of IP addresses, an intermediary network or system (for example, a Tor network, a proxy server, a residential IP, a commercial IP, a virtual private network, etc.), and the like.

At S460, a degree of abnormality of the combination of factors of the fingerprint is determined. In an embodiment, determining the degree of abnormality includes generating a score representing the degree of abnormality. In some embodiments, the combination of factors among each fingerprint that is analyzed to determine degree of abnormality is a predetermined subset of factors or otherwise a predetermined set of factors among potential factors included in a fingerprint. In a further embodiment, the predetermined combination of factors analyzed to determine degree of abnormality may depend on an application or client which performed the access attempt.

In an embodiment, the degree of abnormality is determined for a given client or application. The degree of abnormality may be determined based on a statistical analysis of combinations of factors for legitimate clients or applications. That is, a combination of factors which appears infrequently (for example, below a predetermined threshold proportion of times) among access attempts by legitimate clients, applications, or both, may be assigned a high degree of abnormality. A high degree of abnormality, in turn, increases the confidence that a given fingerprint is malicious.

At S470, a confidence score is generated based on any or all of S430 through S460. The confidence score indicates a likelihood that the fingerprint is malicious. In some embodiments, the confidence score may be generated using a weighted scoring algorithm that assigns weights to scores representing the results of any or all of S430 through S460. To this end, in such an embodiment, each of S430 through S460 may yield a score representing a degree of abnormality or otherwise a metric for which higher scores indicate an increased likelihood that a given fingerprint is malicious.

At S480, the fingerprint is classified based on the generated confidence score. In an embodiment, the fingerprint is classified as either being malicious or benign, where a malicious fingerprint is likely being used by a threat actor to perpetrate a cyberattack and a benign fingerprint is consistent with normal (non-cyberattack) activity. In an embodiment, the fingerprint is classified as malicious when the confidence score is above a predetermined threshold; otherwise, the fingerprint may be classified as benign.

In some embodiments, a fingerprint may only be classified as benign if the fingerprint was observed at least a threshold number of times (either in a given time period or historically) and the success rate is above a threshold. Such embodiments may avoid false negative benign classifications. In such embodiments, if a fingerprint is neither classified as malicious nor benign, the fingerprint may be either assigned a null classification or may not be assigned a classification. Records of fingerprints which were previously observed may be maintained even without a malicious or benign classification, for example, in order to subsequently determine if fingerprints are malicious or benign based on subsequent observations of the fingerprints.

At S490, it is determined whether more fingerprints are to be classified and, if so, execution continues with S410; otherwise, execution terminates.

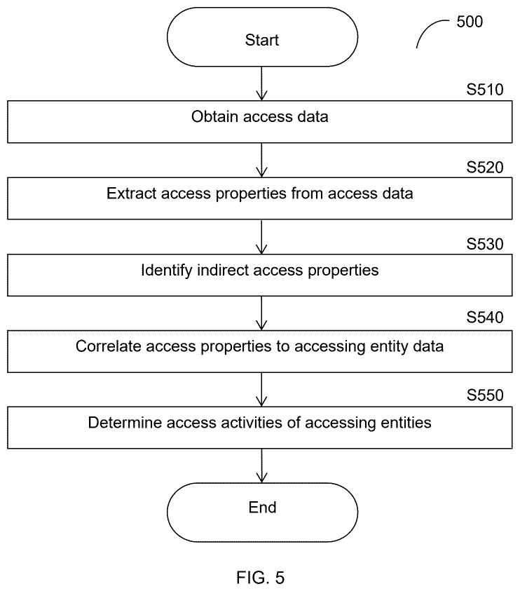

FIG. 5 is a flowchart 500 illustrating a method for correlating between identities and resource access according to an embodiment. In an embodiment, the method is performed by the threat actor detector 130, FIG. 1.

At S510, access data is obtained. The access data may include, but is not limited to, log data or other data indicating access events such as log in or sign in events. In an embodiment, the access data obtained at S510 at least indicates sources of accessing entities participating in access events as well as times for each of the access events. Each of these accessing entities may be the accessing entity who initiated the access event, or may be an intermediary through which another target entity participated in the access event. When an intermediary is used by the target entity to initiate the access event indirectly, the access data may indicate information identifying the intermediary which, in turn, may be utilized to identify appropriate data of the intermediary in order to correlate entities to access events as discussed below.

The network configuration of the accessing program or system may be defined with respect to network locations such as, but not limited to, network addresses, network identifiers such as names, network roles (for example, proxy server, router, virtual private network, residential network, commercial network, etc.), types of networks, geographic locations, a combination thereof, and the like. In particular, it is noted that Internet Protocol (IP) addresses are a type of network address which can be used to effectively correlate the entity to a given access event when log data for the access event indicates an IP address of the accessing entity. The time for each access event may be a time at which access was attempted (e.g., a time at which credentials were transmitted for authentication or when a request for access was transmitted as indicated in a timestamp for data packets including such credentials or request) or a time at which access was completed (e.g., a time at which access was granted to the accessing entity).

At S520, access properties are extracted from the access data with respect to access events represented in the access data. Each access event includes an access attempt performed in order to access a service, a resource, both, and the like. At least some of the access events may include authentication, for example, through a log in or sign in procedure in which credentials (e.g., username and password or keys) are provided. For such authentication-based access events, access to one or more services and/or resources is granted upon an authentication system being provided the applicable credentials. As noted above, access provider systems (e.g., the access provider systems 120, FIG. 1) may store data related to access events such as data about the entity attempting access (e.g., a location of a resource attempting to access another resource or a service), about the circumstances of the access (e.g., a time at which credentials were submitted or access was otherwise initiated, or a time at which access was granted or otherwise completed).

In an embodiment, the access properties to be extracted include location-based access properties and time-based access properties. In a further embodiment, the location-based access properties include a network location such as, but not limited to, an Internet Protocol (IP) address. In another embodiment, the time-based access properties include a time at which an access event was initiated or a time at which the access event was completed (for example, when access is granted).

At optional S530, indirect access properties are identified based on the access data. The indirect access properties include access properties of an indirect access event, i.e., an access event which is an intermediate step before accessing a service or resource in another access event. As a non-limiting example, an indirect access event may include accessing a secrets manager which manages access to such other service or resource. The indirect access event involves accessing an intermediate service or resource other than the target service or resource, where accessing the intermediate service or resource allows for access to the underlying target service or resource. In other words, the indirect access event involves accessing a target service or resource through another service or resource rather than accessing the target service or resource directly.

The indirect access properties may represent an entity which is not explicitly indicated in the access data. For example, when the access event is performed via a secrets manager, the secrets manager may be indicated as the accessing entity in the access logs. However, the secrets manager is not the underlying target accessing entity which actually initiated the access event and is, instead, an intermediate accessing entity used to facilitate and/or manage access. To this end, in some embodiments, identifying the indirect access properties may include determining that the accessing entity indicated explicitly in the access logs is an intermediate accessing entity, and analyzing indirect access data for the intermediate accessing entity in order to identify the indirect access properties. Such indirect access data may include, but is not limited to, secrets manager logs indicating information related to use of the secrets manager (e.g., times of requests sent to the secrets manager, sources of entities which used the secrets manager, etc.). When indirect access properties are utilized, the source and time extracted for use in correlation as discussed herein may be extracted from the indirect access data.

In some embodiments, S530 further includes determining an identity used for the indirect access. As a non-limiting example, when the indirect access of an access event includes accessing a secrets manager in order to gain access to another resource or service, the determined identity may be the identity used to access the secrets manager. The identity may be, for example, a device identity or other identity which may be assigned to a given computing entity in order to facilitate access by that entity to one or more resources, services, and the like. As a non-limiting example, the identity may be a role associated with certain permissions that, when assigned to an entity, grants the entity the associated permissions. In accordance with various disclosed embodiments, such associated permissions include permissions for accessing predetermined target resources or services, and may further include permissions with respect to intermediate services or resources such as secrets managers used for indirectly accessing the target resources or services.

At S540, the access properties extracted at S520, identified at S530, or both, are correlated to accessing entity data related to respective computing entities such as, but not limited to, resources in one or more computing environments. In an embodiment, the access properties which are used to correlate with the accessing entity data include at least aspects of a network configuration used by an endpoint (for example, an accessing program or system) participating in an access attempt of the access event as well as time-identifying access properties indicating a time of the access event. The network configuration of the endpoint and time of a given access event may be correlated to known sources for respective entities at that time in order to determine which of those entities was the accessing entity that initiated that access event.

More specifically, the source-identifying access properties may be or may include location-based indications of source, i.e., indicating a source location from which an entity initiated an access event. Such location-based indications of source may include, but are not limited to, network addresses (e.g., IP addresses), geographic locations, specific networks or subnetworks, combinations thereof, portions thereof, and the like.

As a non-limiting example, an IP address of an entity which initiated an access event in a given computing environment at a particular time are correlated with resource data indicating known IP addresses of respective entities operating within the computing environment at that time in order to determine which entity initiated the access event.

In this regard, it is noted that access logs and other access data are often managed or generated by third-party access service providers who do not have full information regarding the entities which are accessing their services such that the access logs cannot provide the full context regarding use of identities, permissions, secrets, and the like. However, access logs often contain information which has been identified as being capable of use for indirectly identifying the accessing entity. In particular, information such as a source (e.g., an IP address) of the entity which attempted to access at a particular time can be correlated to known sources of entities operating in or with a computing environment in order to identify which entity in the access event. Such an entity may be, for example, an application having a given application identifier (ID) or an identity which might be a machine identity (for example, an identity utilized by an automated program or system in order to allow the program or system to access certain resources).

An example process for correlating access properties to computing entities is described further in U.S. patent application Ser. No. 18/602,642, assigned to the common assignee, the contents of which are hereby incorporated by reference.

At S550, access activities of respective entities are determined based on the correlation. The access activities include, but are not limited to, initiating access events by at least attempting to access resources, services, or both, within a computing environment, or by using an intermediary in order to attempt an access. The determined access activities may further include whether the entity which initiated each access event was successfully granted access. Accordingly, the access activities may be identified with respect to access attempts, and correlations between the access activities and accessing entities may be utilized to determine entities associated with different access attempts. The identifications of the accessing entities involved in different access attempts may be included in fingerprints or may be utilized to determine factors for fingerprints as discussed above.

In some embodiments, S550 may further include grouping the determined access activities. More specifically, the access activities may be grouped with respect to characteristics of the respective entities which initiated the access events of these access activities. As non-limiting examples, the access activities may be grouped based on access events initiated by entities of the same type (e.g., virtual machine, software container, etc.), assigned to the same identity or to identities among a predefined group of identities, entities deployed in the same area within the computing environment, and the like. Grouping the access activities based on the entities which initiated access events may allow for providing visibility into entities whose access activities are more likely to be related. This visibility, in turn, may be leveraged to identifying multiple access attempts by the same fingerprint with more confidence (for example, when used to generate a confidence score that a fingerprint is malicious), which in turn allows for more accurately detecting potential threat actors.

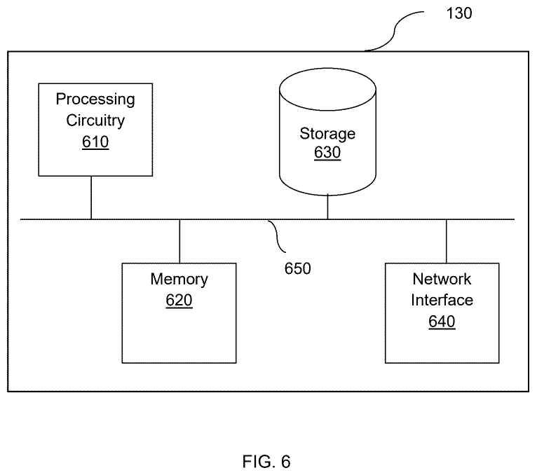

FIG. 6 is an example schematic diagram of a threat actor detector 130 according to an embodiment. The threat actor detector 130 includes a processing circuitry 610 coupled to a memory 620, a storage 630, and a network interface 640. In an embodiment, the components of the threat actor detector 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the threat actor detector 130 to communicate with other systems, devices, components, applications, or other hardware or software components, for example as described herein.

It should be understood that the embodiments described herein are not limited to the specific architecture illustrated in FIG. 6, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for threat actor detection, comprising:
generating a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt;
identifying a plurality of second access attempts involving the fingerprint;
determining a success rate for the plurality of second access attempts involving the fingerprint;
classifying the fingerprint as malicious based on the success rate, wherein the fingerprint is classified as malicious when the success rate is below a threshold; and
performing at least one remediation action based on the classification of the fingerprint as malicious.

2. The method of claim 1, wherein the plurality of factors further includes an identifier of a resource which is a target of the first access attempts.

3. The method of claim 1, wherein the plurality of second access attempts is made to a plurality of services.

4. The method of claim 1, wherein the fingerprint is classified as malicious based further on an error type for at least one second access attempt of the plurality of second access attempts.

5. The method of claim 1, wherein the at least one remediation action includes defining a parameter blacklist based on the fingerprint, wherein the parameter blacklist includes a plurality of parameters such that access is blocked when the plurality of parameters is observed, wherein the plurality of parameters correspond to at least a portion of the plurality of factors.

6. The method of claim 1, wherein the at least one remediation action includes triggering a secrets rotation process.

7. The method of claim 1, wherein the at least one remediation action includes blacklisting the fingerprint.

8. The method of claim 1, wherein at least one of the plurality of factors corresponds to at least one hard-coded parameter of an automated process.

9. The method of claim 1, wherein the fingerprint is a persistent fingerprint, wherein the plurality of factors used to define the fingerprint repeat across access attempts made by an entity using an automated process.

10. A non-transitory computer readable medium having stored thereon instructions for causing a processing circuitry to execute a process, the process comprising:
generating a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt;
identifying a plurality of second access attempts involving the fingerprint;
determining a success rate for the plurality of second access attempts involving the fingerprint;
classifying the fingerprint as malicious based on the success rate, wherein the fingerprint is classified as malicious when the success rate is below a threshold; and
performing at least one remediation action based on the classification of the fingerprint as malicious.

11. A system for threat actor detection, comprising:
a processing circuitry; and
a memory, the memory containing instructions that, when executed by the processing circuitry, configure the system to:
generate a fingerprint based on access data for a first access attempt, wherein the fingerprint includes a plurality of factors, wherein the plurality of factors includes a set of software components used for the access attempt, a version of each software component among the set of software components, and a network configuration of an endpoint participating in the access attempt;
identify a plurality of second access attempts involving the fingerprint;
determine a success rate for the plurality of second access attempts involving the fingerprint;
classify the fingerprint as malicious based on the success rate, wherein the fingerprint is classified as malicious when the success rate is below a threshold; and
perform at least one remediation action based on the classification of the fingerprint as malicious.

12. The system of claim 11, wherein the plurality of factors further includes an identifier of a resource which is a target of the first access attempts.

13. The system of claim 11, wherein the plurality of second access attempts is made to a plurality of services.

14. The system of claim 11, wherein the fingerprint is classified as malicious based further on an error type for at least one second access attempt of the plurality of second access attempts.

15. The system of claim 11, wherein the at least one remediation action includes defining a parameter blacklist based on the fingerprint, wherein the parameter blacklist includes a plurality of parameters such that access is blocked when the plurality of parameters is observed, wherein the plurality of parameters correspond to at least a portion of the plurality of factors.

16. The system of claim 11, wherein the at least one remediation action includes triggering a secrets rotation process.

17. The system of claim 11, wherein the at least one remediation action includes blacklisting the fingerprint.

18. The system of claim 11, wherein at least one of the plurality of factors corresponds to at least one hard-coded parameter of an automated process.

19. The system of claim 11, wherein the fingerprint is a persistent fingerprint, wherein the plurality of factors used to define the fingerprint repeat across access attempts made by an entity using an automated process.
